(19) United States
(12) Patent Application Publication
(10) Pub. No.: US 2015/0260084 A1
(43) Pub. Date: Sep. 17, 2015

(54) THRUST PROPULSION SYSTEM

(71) Applicant: LUNAIR PTY. LIMITED, Sydney (AU)

(72) Inventor: Palle Lunoe, New South Wales (AU)

(21) Appl. No.: 14/431,213

(22) PCT Filed: Sep. 27, 2013
(86) PCT No.: PCT/AU2013/001119

§ 371 Date: Mar. 25, 2015

(30) Foreign Application Priority Data
Sep. 28, 2012 (AU) 2012904250

(51) Int. Cl. F02B 37/00; F02C 6/12

(52) U.S. Cl. CPC F02B 37/005; F02C 6/12

(57) ABSTRACT

A magnetic flux coupler comprising a magnetically permeable core having a first axis, two coils magnetically associated with the core, each coil defining a pole area located on a first side of the core and the pole areas being separated along the first axis, the coils each having a central region located between the pole areas, an end region opposite to the central region, and a side region between the central region and the end region, wherein an auxiliary pole area is provided beyond the end region of each coil which absorbs leakage flux which would otherwise emanate from the each coil in use in the vicinity of the end region.

### TECHNICAL FIELD

The present invention generally relates to a propulsion system or engine for providing thrust. In another form, the present invention generally relates to a system for providing a high volume air compressor. More particularly, in one non-limiting form the present invention relates to a jet propulsion system or engine.

### BACKGROUND

Turbochargers are well known in the art for supplying relatively high pressure air to internal combustion engines, such as a reciprocating piston engine. Typically, the turbocharger includes a turbine for receiving exhaust gases expelled from the engine. The turbine is typically supported by a rotatable shaft connected to a compressor including an impeller within a compressor housing. The turbine is driven by exhaust gases from the engine and in turn drives the compressor's impeller which draws ambient air into the compressor housing for compression and discharge to an intake manifold of the engine.

Turbocharged engines are highly advantageous when compared with conventional naturally aspirated engines in that substantially denser air can be delivered to the engine. This increased air density or mass permits the engine to be operated at substantially increased levels of performance and power output, and frequently with, greater efficiency. It is necessary to control the operation of the turbocharger so that air is supplied to the engine only on demand at a pressure level not exceeding a predetermined design limit. It is conventional to provide a passage for bypassing exhaust gases around the turbine and including a wastegate valve for opening and closing this bypass passage. A turbocharger is often used as an accessory to an internal combustion engine and is positioned in-line on an exhaust gas manifold. The turbochargers purpose is to extract pressure and kinetic energy from the exhaust gases of the internal combustion engine to power a centrifugal compressor. The compressor compresses relatively large volumes of ambient air. The compressed air is then delivered to the engine intake after being mixed with fuel.

The increased mass of air delivered to the engine (compared to that of a non-turbocharged engine) allows for an increased amount of fuel to be burnt at the correct fuel/air mixture. This results in increased power production from the engine. Air is ingested into the compressor from the ambient atmosphere. The air is then compressed and normally delivered into the engine, having been mixed with fuel or diesel to create a charge. This fuel/air charge is then burnt and pressure energy is extracted from the expanding air via the use of a piston and transferred to mechanical energy. Extremely hot and expanding air is ducted to the turbine housing of the turbocharger. Heat/pressure energy is extracted from the exhaust airflow to rotate turbine blades, which in turn drive the compressor. Waste gasses are vented to the atmosphere.

An example known turbocharged engine is now described in more detail by reference to U.S. Pat. No. 4,774,812. Referring to FIG. 1, a turbocharged engine 1 has a combustion chamber 3 defined above a piston 2. Intake and exhaust ports 6 and 7 are opened and closed respectively by intake and exhaust valves 4 and 5 open to the combustion chamber 3. An intake passage 8 is connected to the intake port 6 and an exhaust passage 9 is connected to the exhaust port 7. The engine 1 is provided with a turbocharger 11 comprising an impeller 11b which is disposed in the intake passage 8 and is driven by a turbine 11a disposed in the exhaust passage 9. An air cleaner 14 is provided on the upstream end of the intake passage 8 and an airflow meter 15 is disposed in the intake passage 8 downstream of the air cleaner 14. A bypass passage 18 connects a portion of the intake passage 8 upstream of the impeller 11b with a portion of the intake passage 8 downstream of the impeller 11b bypassing the impeller 11b, i.e., the bypass passage 18 directly connects a portion of the intake side passage 12 of the impeller 11b with a portion of the discharge side passage 13 of the same. The discharge side passage 13 leads to the intake port 6 by way of a throttle valve 16 and a surge tank 17. The amount of air introduced into the impeller 11b and the amount of air introduced into the bypass passage 18 are controlled by a valve means 19. The valve means 19 comprises a bypass valve 20 disposed in the bypass passage 18 and a flow control valve 21 disposed in the discharge side passage 13 of the impeller 11b. The bypass valve 20 is a check valve and the flow control valve 21 is driven by an actuator 22. The opening of the flow control valve 21 is controlled according to the operating condition of the engine 1 under the control temperature signal from a coolant temperature sensor 24, an engine rpm signal from an engine speed sensor 25 and an intake pressure signal from a pressure sensor 26 are input into the engine control unit 23, the intake pressure signal representing the pressure in the intake passage 8 downstream of the throttle valve 16. A fuel injection valve 27 is provided in the intake passage 8 near the intake port 6. The exhaust passage 9 is provided with a bypass passage which bypasses the turbine 11a of the turbocharger 11 and is selectively opened by a waste gate valve 28, and a catalytic convertor 29 is disposed downstream of the turbine 11a. The engine control unit 23 obtains a signal representing flow of exhaust gas from the engine rpm and the intake pressure, and fully opens the flow control valve 21 and fully closes the bypass valve 20 during heavy load operation so that only pressurized air pressurized by the impeller 11b is introduced into the combustion chamber 3.

There is a continual search for improvements in engines, turbochargers, thrust systems, air compressor systems, and the like, and in the operational efficiency thereof. There are broad and various uses of engines and thrust systems, such as in aviation, automobiles, marine, etc., and these applications can benefit from factors such as improved efficiency, thrust and/or power output. There is an ongoing need for new or improved propulsion systems or engines, high volume air compressors, and the like.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### SUMMARY

This Summary is provided to introduce a selection of concepts in a simplified form that are further described below in the Preferred Embodiments. This Summary is not intended to identify key features or essential features of the claimed subject matter, nor is it intended to be used to limit the scope of the claimed subject matter.

In one form, the present invention provides a propulsion system, for example a jet style thrust propulsion system. By way of example only, the propulsion system can be used in aviation engine applications as a means of providing thrust, for example as an aircraft engine, however, the propulsion system also can be used in a wide variety of other applications as a means of providing thrust or propulsion forces including automobile and marine applications.

The propulsion system also can be used not to generate thrust, but as a means for providing relatively high volumes of air at relatively high pressures, velocities or both in various different capacities, such as for application in industrial air compression, wind tunnels, cooling air systems, and the like.

Various embodiments of the invention can utilise any form of engine or other power source, such as an internal combustion engine, Wankel rotary engine, turbine engine or electric motor, or a combination thereof, that provides mechanical energy. In a preferred form, this energy is harnessed to provide a source of compressed air to other components of the system which multiplies air volume, pressure and/or velocity. In various forms, this harnessed energy, directed as air or gas masses, can be utilised through a system of air ducts, pipes, tubes, manifolds, and the like, and a variety of nozzles, valves, flow controllers, and the like, to achieve overall improved efficiency and/or power output of the system.

Reference to one or more pipes for transporting air or other gases should be read as a reference to any form of air ducts, pipes, tubes, manifolds, and the like. In some applications a single pipe may be used, in other applications a plurality of pipes may be used, for example providing a manifold.

Reference to a valve for regulating, controlling or directing airflow (or equally other gasflow) should be read as a reference to any type of nozzle, valve, controller, regulator and the like which regulates, controls or directs airflow.

Preferably, in one form, the flow of air mass (or equally other gas mass) is a relatively cool or cold air mass, compared to normal turbocharger operation temperatures, with only minor adiabatic and frictional heating. Additional fuel can be burnt utilising combustion chambers or afterburners in the airflow to achieve an increase in airflow qualities, if required, at almost any phase in the propulsion system to achieve a desired result.

A principle advantage of the propulsion system arises from previously unknown usage or application of turbochargers. Instead of using a turbocharger to increase power in an internal combustion engine, in an embodiment of the present invention the turbocharger is used to create thrust. By taking a relatively small amount of air mass/volume to drive the turbine, and producing a relatively large air mass/pressure/velocity as created by the compressor, the total air mass can be effectively multiplied. The exhaust air from the turbine, which would normally be expelled as waste via an exhaust pipe, is re-introduced back into the airflow and can be utilised as thrust, for example provided at an exhaust, nozzle, eductor, ejector or the like. In one form, the propulsion system utilises a turbocharger that is operated in a novel manner as the turbocharger is driven by both a typical pressure differential as well as imposing a vacuum, near-vacuum or reduced pressure region on one side (lower pressure side) of the turbocharger.

The ability of the system to effectively multiply the overall air mass can also become more efficient by the use of relatively cool or cold air as opposed to relatively hot combusted air as would normally be found in known turbocharger operation.

According to a first example form, there is provided a propulsion system comprising: an engine; a first compressor able to be driven by the engine, the first compressor for producing a first compressor output flow; a turbine able to be driven by at least part of the first compressor output flow; a second compressor able to be driven by the turbine, the second compressor for producing a second compressor output flow; wherein in operation at least part of the second compressor output flow and at least part of the first compressor output flow are combined to produce thrust.

According to a second example form, there is provided a propulsion system comprising: at least one engine; at least one first compressor able to be driven by the at least one engine, the at least one first compressor for producing at least one first compressor output flow; a plurality of turbines able to be driven by at least part of the at least one first compressor output flow; a plurality of second compressors able to be driven by one or more of the plurality of turbines, the plurality of second compressors for producing a plurality of second compressor output flows; wherein in operation at least part of the plurality of second compressor output flows and at least part of the at least one first compressor output flow are combined to produce thrust.

In other particular, but non-limiting, forms: a flow controller controls an amount of the first compressor output flow directed to the turbine; the flow controller is positioned between the first compressor and the turbine; and/or the flow controller is positioned between the first compressor and an exit device.

In accordance with further example embodiments, provided by way of example only: the turbine and the second compressor are part of a turbocharger; in operation a turbine output flow exits the turbine; the turbine output flow is directed to an exit device; and/or the exit device includes an ejector, eductor, nozzle and/or pipe, individually or in combination. In one form, the exit device is a novel exhaust device, unit or system that comprises a De Laval nozzle and an ejector. The De Laval nozzle and the ejector can be combined as a single or integrated device, unit or system to provide the exhaust device.

According to yet further optional aspects, provided by way of example only: operation of the exit device causes a decrease in pressure of the turbine output flow; in operation the engine produces an exhaust flow, and the exhaust flow contributes to produce the thrust; and/or the exhaust flow is directed to the exit device and bypasses the turbine.

Optionally, but not necessarily, the engine is an internal combustion engine, the engine is a jet aircraft engine, the thrust acts on the propulsion system, and/or the flows, such as the first compressor output flow and the second compressor output flow, are comprised of air and/or other gases and are directed within pipes.

In still further particular, but non-limiting, forms: one or more flow controllers control an amount of the at least one first compressor output flow directed to each of the plurality of turbines; in operation the engine produces an exhaust flow, and the exhaust flow is directed to a separate exhaust flow turbine; and/or in operation the exhaust flow turbine drives an exhaust flow compressor that produces an exhaust flow compressor output flow which is combined with the plurality of second compressor output flows and/or at least part of the at least one first compressor output flow.

### BRIEF DESCRIPTION OF FIGURES

Example embodiments should become apparent from the following description, which is given by way of example only, of at least one preferred but non-limiting embodiment, described in connection with the accompanying figures.

FIG. 1 (prior art) illustrates a known example turbocharged engine;

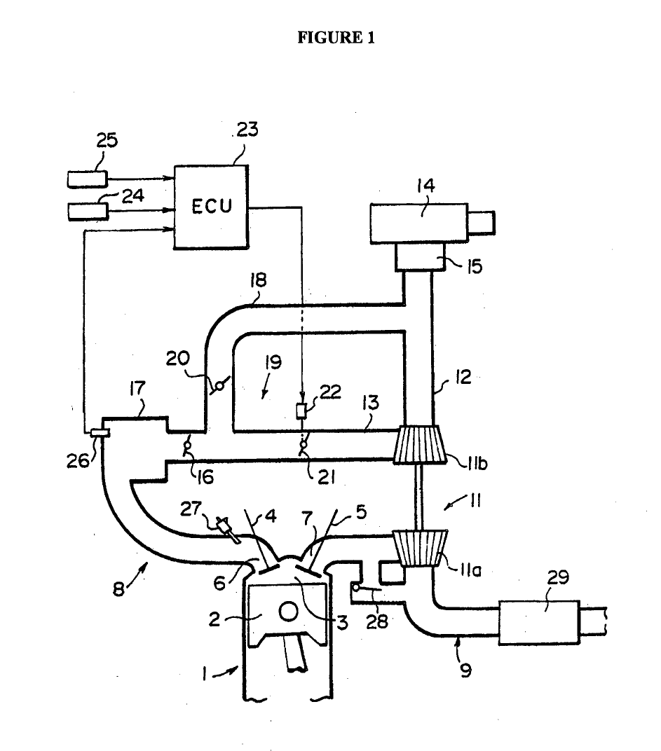

FIG. 2 illustrates an example thrust propulsion system;

FIG. 3 illustrates a more complex embodiment of an example thrust propulsion system;

FIG. 4 illustrates a further embodiment of an example thrust propulsion system;

FIG. 5 illustrates a partial cross-section of an example manifold or nozzle design near an exit region for a thrust propulsion system.

FIG. 6 illustrates a partial cross-section of another example manifold or nozzle design near an exit region for a thrust propulsion system.

### PREFERRED EMBODIMENTS

The following modes, given by way of example only, are described in order to provide a more precise understanding of the subject matter of a preferred embodiment or embodiments. In the figures, incorporated to illustrate features of an example embodiment, like reference numerals are used to identify like parts throughout the figures.

### Thrust Propulsion System

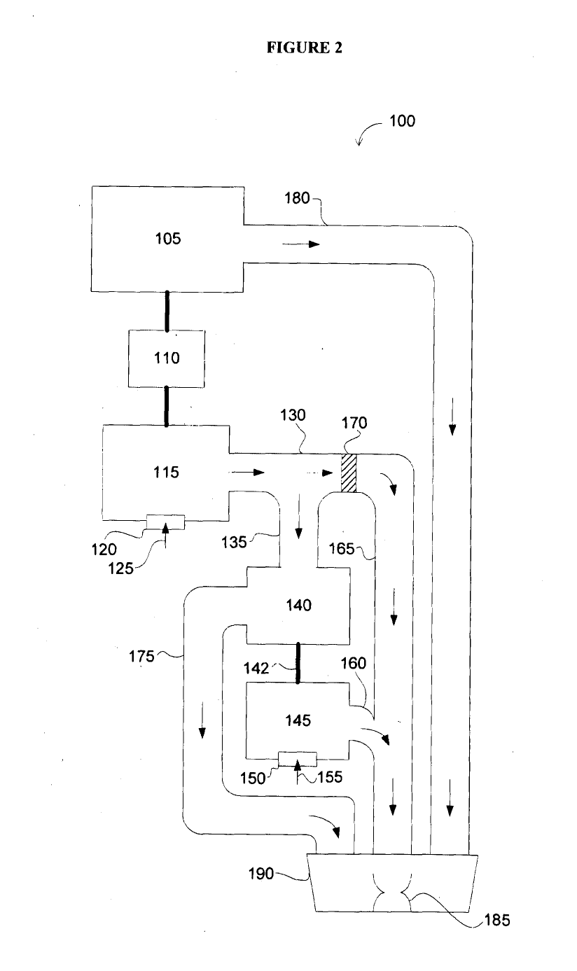

Referring to FIG. 2 there is illustrated an example thrust propulsion system 100. The thrust propulsion system 100 shows how a standard turbocharger can be utilised in a system 100 to multiply air mass and pressure, which can be converted into a higher velocity, and therefore used to increase overall thrust acting on system 100.

Engine 105 can be a wide variety of engine types that provide power, for example an internal combustion engine, Wankel rotary engine, jet turbine engine, electric motor, or a combination thereof, or any other power source that provides sufficient power to drive initial compressor 115. One or more engines 105, being the same or different types of engine, can be used as required for particular applications. One or more initial compressors 115, being the same or different types of compressors, can be used as required for particular applications. The propulsion system or engine can be used in aviation engine applications as a means of providing thrust, for example as an aircraft engine, such as in an aeroplane or a helicopter. However, the propulsion system or engine can also be used in a wide variety of other applications as a means of providing thrust or propulsion forces, including land-based applications such as in an automobile or other vehicle, and marine-based applications such as in a boat or ship.

Transmission 110 mechanically connects engine 105 and initial compressor 115. Transmission 110 can be or include, for example, a gearbox, planetary gearbox, belt drive, pulley drive, shaft or shafts, or the like. Depending on the type of engine 105 and initial compressor 115, a gear system may (or may not) be required to drive the initial compressor 115. In some embodiments, transmission 110 may not be required, for example the initial compressor 115 may form part of or otherwise be integrated with engine 105.

Initial compressor 115 can be any type of compressor that can supply a required air mass at a required pressure and velocity to enable operation of the propulsion system 100. Initial compressor 115 can include any number or any size of compressors dependant on the requirements of the propulsion system 100. If multiple initial compressors 115 are used, the compressors can be placed in series (compound) or parallel to achieve a desired pressure and mass of airflow. Air intake 120 allows air 125 to be input into initial compressor 115, preferably from the atmosphere as ambient air. Air intake 120 may be a pipe, duct, channel, opening, filter or the like.

One or more pipes 130 carries the output compressed air or gross product (i.e. initial compressor output flow) from initial compressor 115 and allows for the air to be directed or split to one or more pipes 165 (i.e. as at least part of the initial compressor output flow) and/or one or more pipes 135 (i.e. as turbine input flow) as required. The airflow, indicated by arrows in FIG. 2, is managed by the use of valve(s) 170. One or more pipes 135 are used to deliver the desired air mass (i.e. turbine input flow) to turbine 140.

The one or more pipes 130, 135, 160, 165, 175 and/or 180 can be in the form of air ducts, pipes, tubes, manifolds, or the like. For efficiency, ease of construction or due to the location of various components, the one or more pipes 130, 135, 160, 165, 175 and/or 180 can include different sections, segments, parts or the like, for example as illustrated or with sections of the one or more pipes connecting to a component from one or more main pipes. Thus, one or more manifolds can be used as the one or more pipes.

Valve(s) 170, which can be a single or multiple valves, can be any type of nozzle, valve, controller, regulator or the like which regulates, controls or directs the airflow. For example, valve(s) 170 may be a butterfly valve or a wastegate. Valve(s) 170 can be of any valve type that allows for the management of airflow, dependant on the conditions of operation required at any given time. In another embodiment, valve(s) 170 need not be utilised and might be made redundant by carefully designed manifolds in some applications.

One or more pipes 165 transport high pressure air from components to propelling nozzle 185 (or nozzles) which is the component of the propulsion system, for example a jet engine, that operates to constrict the airflow to form an exhaust jet. Nozzle 185 increases or maximises the velocity of propelling gases from the propulsion system. A variety of propelling nozzles and geometries can be used, for example subsonic, sonic, or supersonic, and may be convergent, or convergent-divergent. One or more pipes 165 may include collectors, extractors, etc., as required or desirable to efficiently present the airflow to propelling nozzle 185.

There are a number of devices that can be used as or in place of nozzle 185, depending on the available air mass, velocity or temperature, so as to direct the air mass flow to atmosphere, or other apparatus, depending on the desired result. In a preferred example, nozzle 185 is a “De Laval” nozzle, utilised to exchange air pressure accumulated in one or more pipes 165 to accelerate the air mass to maximum possible velocity, preferably supersonic velocity. Another example of possible nozzle selection may be a purely divergent duct to exchange air velocity in one or more pipes 165 for air pressure. This may be useful for situations requiring large amounts of very high pressure air.

One or more pipes 160 transport high pressure and/or high velocity air masses (i.e. second compressor output flow) from one or more compressors 145 (i.e. turbocharger or second compressor 145) to one or more pipes 165 where all, substantially all, or at least part of, the second compressor flow output can be combined with the initial compressor flow output or at least part (the remainder) thereof. It is preferred that all of the second compressor flow output is directed to one or more pipes 165 for combination with the initial compressor flow output, or remainder thereof. However, it is possible that only part of the second compressor flow output is directed to one or more pipes 165, for example if a fraction of the second compressor flow output is desired for some other application or use.

It should be appreciated that throughout this specification reference to combining, directing, or otherwise, an output flow should be read as referring to any of all, substantially all, at least part of, or a fraction of, the output flow. For example, an output flow could be described as being directed to or combined with another output flow, however it should be understood that a fraction or part of any of the output flow(s) could be directed elsewhere for other uses or applications. That is, reference to an output flow also encompasses reference to at least part of the output flow.

One or more pipes 175 transport “exhaust” air (i.e. turbine output flow) from one or more turbines 140 (i.e. turbocharger turbine 140). Preferably, to increase the efficiency of turbine 140 operation, the exhaust air is maintained with the lowest possible back pressure against turbine 140. The exhaust air can be expelled to the atmosphere, or as in the illustrated embodiment the exhaust air can be optionally delivered to exit device 190, preferably termed an ejector, which is optional, and which aids in the active extraction of exhaust air masses. Thus, in an example form, compressor 145 and turbine 140 are component parts of a standard turbocharger, or can be customised if desired or necessary. Connection 142 connects turbine 140 to compressor 145 so that compressor 145 can be driven by rotation of turbine 140. Connection 142 can be a variety of mechanisms as known in standard turbochargers, such as a shaft, axle, rod, geared connection, or any other means for transferring rotational energy. For clarity, a plurality of turbochargers could be used providing a plurality of turbocharger compressors and turbocharger turbines. Air intake 150 allows air 155 to be input into compressor 145, preferably from the atmosphere as ambient air. Air intake 150 may be a pipe, duct, channel, opening, filter or the like.

Exit device 190 (i.e. air or gas flow exit device) can include an ejector, eductor or a venturi type tube or arrangement in combination with a nozzle 185. That is, exit device 190 could operate to provide a Bernoulli effect or a Venturi effect at the gas exit region. Preferably, exit device 190 includes an ejector used in conjunction or combination with the high velocity air exiting nozzle 185 to create a vacuum, partial vacuum or reduced pressure, in one or more pipes 175. This has the effect of increasing the pressure drop across turbine 140. As turbine 140 requires a mass flow of air with a pressure ratio from one side to the other, the increased pressure drop increases the efficiency of operation of turbine 140. The result being that less air pressure is required from initial compressor 115 to drive turbine 140. This arrangement has the added benefit of re-introducing the air mass into the thrust airflow and thus increasing the overall mass of air used for thrust. In one embodiment, exit device 190 provides an exhaust device, unit or system that comprises a De Laval nozzle 185 and an ejector. The De Laval nozzle 185 and the ejector can be combined as a single or integrated device, unit or system to provide the exhaust device.

It should be noted that for an embodiment to expel the air mass from one or more pipes 175 into the atmosphere, exit device 190 (e.g. ejector) or the actual position of any other component can be dependant on the application for which the propulsion system is used. In the illustrated example, as thrust is partially dependant on mass flow of air, the air is run to an eductor/ejector/venturi (i.e. exit device 190) to increase the total mass flow of air that is accelerated and utilised as thrust. At the same time, a vacuum effect created by the eductor/ejector/venturi in one or more pipes 175 helps create a larger pressure differential through the turbocharger turbine 140, therefore increasing its efficiency and decreasing the amount of air required from initial compressor 115 to power turbine 140 of the turbocharger. The end result being that a larger component of air mass from initial compressor 115 can be used directly for thrust. Alternatively, if a lesser mass/weight of air is acceptable but a large volume of higher pressure air is the desired result, the small portion of low pressure air from one or more pipes 175 can be exhausted to atmosphere as waste and the remaining bulk of the airflow maintains a higher pressure and average velocity.

One or more pipes 180 provide one or more engine exhaust pipes. The exhaust pipe(s) 180 can transport engine exhaust gases (i.e. engine exhaust flow) and perform any of the following tasks depending on system requirements:

exhaust air can be expelled from the propulsion system 100 to atmosphere (standard exhaust pipe);

exhaust air can be directed to optional exit device 190 and combined using one or more pipes with other air flows to provide a total air mass providing the thrust of the propulsion system (the embodiment as illustrated). The total air mass can exit via nozzle(s) 185.

Turbocharger compressor(s) 145 can be a standard turbocharger centrifugal compressor, driven by turbocharger.turbine(s) 140. Turbocharger compressor(s) 145 can be re-designed to utilise any type of compressor, such as axial flow compressors, squirrel cage compressors, etc., to achieve the desired mass airflow, pressure or velocity, as required. Turbocharger turbine(s) 140 can be a standard turbocharger pressure turbine. Variation of this design are possible and can include, for example, velocity turbines, blow down turbines or even combinations of turbines to drive turbocharger compressor(s) 145.

In another embodiment, axial flow turbines, blow down turbines, etc., can be added after the pressure turbine 140 to extract further energy from the airflow, noting that the vacuum or partial vacuum applied to the lower pressure side of the turbine increases the available energy for a given input on the higher pressure side of the turbine.

In a further embodiment, in relation to compressor 145, pressure is of importance as a De Laval nozzle, is most responsive to additional pressure as opposed to volume. The increased efficiency of the turbine section allows for the introduction of axial flow compressors to increase pressure, volume or both. A combination of axial flow and centrifugal flow compressors could be used to achieve maximum increases in pressure and volume whilst maintaining high velocity values in one or more pipes 165.

It should also be noted that depending on the degree to which the pressures and velocities are matched between adjoining one or more pipe sections (e.g. manifolds), non return valves may be used, or required, to avoid reverse airflow within the propulsion system at various locations. Non return valves also may be used to reduce losses in the event of component failure. Furthermore, digital or analog pressure controllers may be used or required to ensure air masses are directed throughout the propulsion system to achieve the desired or an optimised result, depending on the selection of machinery to be utilised as well as the particular application. Also, the use of convergent/divergent duct theory, collectors, extractors, etc., can be utilised to optimise airflow velocity and pressures to obtain desired results in pipe sections.

Example Differences from Standard Turbocharger Use

The following points are provided by way of example to highlight some differences between present embodiments and known uses of turbochargers. These example differences should not be construed as limiting the scope of the present invention.

The turbocharger, comprising turbine 140 and compressor 145, is not used as an accessory to an engine, that is in-line on an exhaust manifold to create additional mechanical power by supplying a compressed air/fuel charge to the engine. An internal combustion engine, or other type of engine, can operate successfully without the use of a turbocharger.

The turbocharger, comprising turbine 140 and compressor 145, is used as a component of a propulsion system to create thrust. The turbocharger is not powered by hot exhaust or waste gases. The turbine 140 is an in-line component on a relatively cooler compressed air manifold for thrust production.

The turbine 140 is powered by a primary compressed airflow. After air mass has passed through turbine 140, the air mass can be reused thus producing and contributing to overall thrust and power values.

In normal use a turbocharger has only one power source, the hot exhaust gas flow. In propulsion system 100, turbine 140 is preferably driven by:
usage of air pressure/velocity from the initial or primary compressor 115 transported into turbine 140; and additionally,
a vacuum, partial vacuum or reduced air pressure, created in one or more pipes 175 by use of an ejector/eductor/venturi (being or included as part of exit device 190).

The Applicant is not aware of any other application where it has been known or possible for a turbocharger to be powered by a relatively cool or cold airflow (i.e. not by post-combustion engine exhaust gases), or an airflow that has not been expanded by burning fossil fuels in a fuel-air charge prior to input to the turbine of the turbocharger. In a preferred embodiment, use of relatively cooler or cold air has been made possible by the use or application of a pressure differential between the input and the exit of the turbine.

The compressed air produced by the initial or primary compressor 115 is not mixed with fuel/diesel to create a charge, whereas for normal supercharger or turbocharger operation compressed air is mixed with fuel/diesel to create a charge in an engine. In a preferred embodiment, the compressed air from initial or primary compressor 115 provides a driving force of thrust itself. Normally, in known supercharger or turbocharger operation, the compressed air would be burnt and expanded to create a larger potential energy. In one view, the compressed air from the initial or primary compressor 115 is the enabling source, for improved efficiency of the overall propulsion system.

### Example Advantages

The operation of turbochargers utilising relatively cool or cold air has a number of further advantages, including for example:
Lack of combustion in the air mass reduces operating temperatures to below about 200° C., resulting in a dramatic reduction of wear on the hot section/turbine and bearings (as is found in normal operations when used in conjunction with an internal combustion engine which produces air/gas temperatures up to about 1000° C.).
This also allows for significantly lighter materials to be used for the turbine housing. Maintenance intervals and reliability are greatly increased.
The use of high pressure, cold, smooth airflow reduces inefficiencies normally produced by the pulses of air that emanate from the exhaust of an internal combustion engine. The smooth airflow delivered to the turbine places less vibration/friction on bearings, which in turn increases efficiency.
The lack of, or reduced, heat in the airflow reduces expansion in the turbine blades which leads to blade deformation and cracking or complete failure. The blades maintain a more uniform shape and operate more efficiently.
The relatively cooler, denser air allows the turbine to operate with improved efficiency.
The ability to utilise exhaust air in production of thrust increases the overall efficiency of the turbocharger.
The ability to apply a vacuum, partial vacuum or reduced air pressure to the low pressure side of the turbine decreases the pressure required to drive the turbocharger at normal operating revolutions per minute (RPM).

Due to at least the factors listed above, an increased efficiency in the turbine section results in an increase of overall thrust produced by the propulsion system when driven by the engine. Alternatively, the same amount of energy can be absorbed by the turbine in the turbocharger and a larger initial or primary compressor can be driven by the engine to create additional thrust. As a result of these improvements, and previously unknown use of a turbocharger, the propulsion system can be used to provide improved thrust, as opposed to power. Alternatively, in another form, the system can be utilised as an extremely high volume air compressor.

One of the major contributing factors to the design of a turbocharger is its ability to spool up with a fast response to engine RPM. As this consideration is not so much a factor in the present propulsion system, basic design changes can be made to the turbocharger without altering the manner in which the turbocharger works.

### Example Output Values

The following output values are obtained from an example implementation of the propulsion system illustrated in FIG. 2. These test values are provided by way of example only as an indication of achievable outputs, and should not be construed as limiting the present invention.

Engine 105 operating parameters:

Power delivered at engine 105=X;

Mass Flow—2.1 kg/s;

Pressure—50 PSI;

Velocity—240 m/s.

Primary airflow from initial compressor—initial compressor 115 produces 2.1 kg/s at 50 PSI to manifold 130 and manifold 165. Valve 170 re-directs primary airflow to manifold 135 as required. Turbine 140 requires a maximum air mass of 0.45 kg/s to drive the turbine. A maximum pressure differential between manifold 135 and manifold 175 of 38 PSI is required.

Compressor 145 produces an additional 1.36 kg/s of air at 60 PSI to manifold 160 and manifold 165. Manifold 165 now has 3.01 kg/s of air at approximately 54 PSI. Nozzle 185 accelerates the air mass to over Mach 2 and ejector 190 accelerates 0.45 kg/s from manifold 175 to Mach 1.2 (thereby creating a partial vacuum in manifold 175).

Thus, at the output:

Power delivered at engine 105 remains constant=X;

Mass flow—3.46 kg/s;

Pressure—ambient;

Average exhaust velocity—550 m/s;

Mass flow from manifold 180 is additional and raises overall velocity.

### Further Example of a Thrust Propulsion System

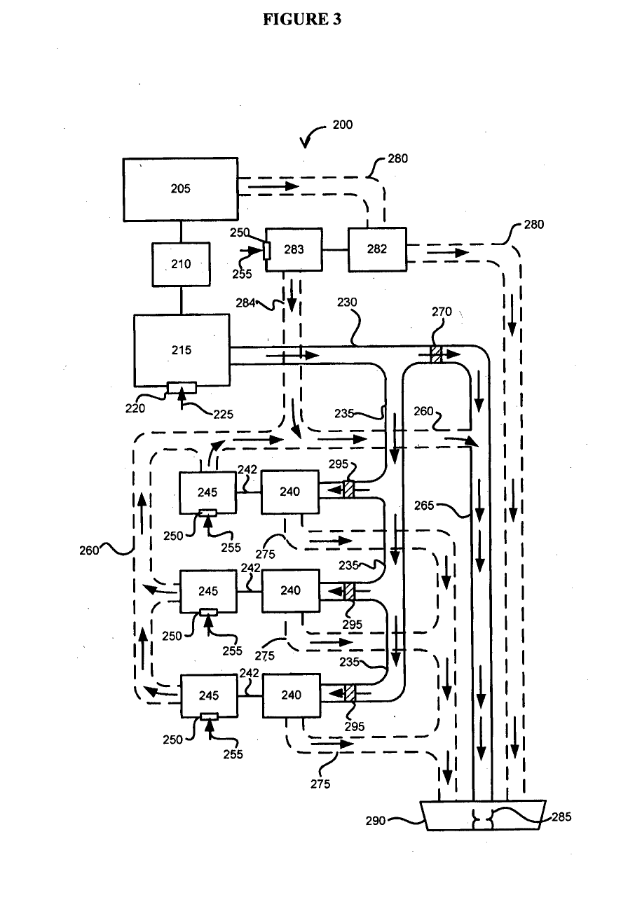

The thrust propulsion system 200 illustrated in FIG. 3 is a more complicated embodiment than propulsion system 100. Thrust propulsion system 200 shows how common or standard turbochargers, or customised versions if desired, can be utilised to multiply air mass and pressure, which can be converted into a higher velocity and therefore used to increase thrust.

Engine 205 can be a wide variety of engine types as described for engine 105. For example, engine 205 may be, but need not necessarily be, an internal combustion engine. One or more engines 205, being the same or different types of engine, can be used as required for particular applications.

Transmission 210 mechanically connects engine 205 and initial compressor 215 as previously described for transmission 110. In some embodiments, transmission 210 may not be required, for example the initial or primary compressor 215 may form part of or otherwise be integrated with engine 205.

Initial or primary compressor 215 can be any type of compressor that can supply a required air mass as previously described for initial compressor 115. Initial compressor 215 can include any number or any size of compressors dependant on the requirements of the propulsion system 200. If multiple initial compressors 215 are used, the compressors can be placed in series (compound) or parallel to achieve a desired pressure and mass of airflow. Air intake 220 allows air 225 to be input into initial compressor 215, preferably from the atmosphere as ambient air. Air intake 220 may be a pipe, duct, channel, opening, filter or the like.

One or more pipes 230 carry the output compressed air or gross product from initial compressor 215 and allows for the air to be directed or split to one or more pipes 265 and/or one or more pipes 235 as required. The airflow, indicated by arrows in FIG. 3, is managed by the use of valve(s) 270, that may be located as illustrated, in one or more pipes 235, or at the junction of pipes. One or more pipes 235 are used to deliver the desired air mass to turbines 240.

The one or more pipes 230, 235, 260, 265, 275 and 280 can be in the form of air ducts, pipes, tubes, manifolds, or the like. For clarity of illustration, different sections of pipes are shown in FIG. 3 with different line styles, and air flow along a pipe section is indicated by arrows of the same line style. To be clear, where different pipe sections cross-over in the figure there is not an exchange of air flow between the pipes, that is the pipes are separated unless specifically mentioned otherwise.

For efficiency, ease of construction or due to the location of various components, the one or more pipes 230, 235, 260, 265, 275 and/or 280 can include different sections, segments, parts or the like, for example as illustrated or with sections of the one or more pipes connecting to a component from one or more main pipes. Thus, one or more manifolds can be used as the one or more pipes.

Valve(s) 270, which may be a single or multiple valves, can be any type of nozzle, valve, controller, regulator or the like which regulates, controls or directs the airflow. For example, valve(s) 270 may be a butterfly valve or a wastegate. Valve(s) 270 can be of any valve type that allows for the management of airflow, dependant on the conditions of operation required at any given time. In another embodiment, valve(s) 270 need not be utilised and might be made redundant by carefully designed manifolds in some applications.

One or more pipes 265 transport high pressure air from components to propelling nozzle 285 which is the component of the propulsion system, for example a jet engine, that operates to constrict the airflow to form an exhaust jet. Nozzle 285 increases or maximises the velocity of propelling gases from the propulsion system. A variety of propelling nozzles and geometries can be used, for example subsonic, sonic, or supersonic, and may be convergent, or convergent-divergent. One or more pipes 265 may include collectors, extractors, etc., as required or desirable to efficiently present the airflow to propelling nozzle 285.

There are a number of devices that can be used as or in place of nozzle 285, depending on the available air mass, velocity or temperature, so as to direct the air mass flow to atmosphere, or other apparatus, depending on the desired result. In a preferred example, nozzle 285 is a “De Laval” nozzle, utilised to exchange air pressure accumulated in one or more pipes 265 to accelerate the air mass to maximum possible velocity, preferably supersonic velocity. Another example of possible nozzle selection may be a purely divergent duct to exchange air velocity in one or more pipes 265 for air pressure. This may be useful for situations requiring large amounts of very high pressure air.

One or more pipes 260 transport high pressure and/or high velocity air masses from compressors 245 (i.e. turbocharger compressors 245) to one or more pipes 265. One or more pipes 275 transport “exhaust” air from turbines 240 (i.e. turbocharger turbines 240). Preferably, to increase the efficiency of operation of turbocharger turbines 240, the exhaust air is maintained with the lowest possible back pressure against turbines 240. The exhaust air can be expelled to the atmosphere, or as in the illustrated embodiment the exhaust air can be optionally delivered to exit device (e.g. ejector) 290 (optional) which aids in the active extraction of exhaust air masses. Thus, in an example form, compressors 245 and turbines 240 are component parts of a standard turbocharger, or can be customised if desired or necessary. Connections 242 can be a variety of mechanisms as known in standard turbochargers, such as shafts, axles, rods, geared connections, or any other means for transferring rotational energy. Air intakes 250 allow air 255 to be input into compressors 245, preferably from the atmosphere as ambient air. Air intakes 250 may be pipes, ducts, channels, openings, filters or the like. Exit device/ejector 290 can be the same as exit device/ejector 190, previously described, and operate in a similar manner.

It should be noted that for an embodiment to expel the air mass from one or more pipes 275 into the atmosphere, ejector 290 or the actual position of any other component can be dependant on the application for which the propulsion system is used. In the illustrated example, as thrust is partially dependant on mass flow of air, the air is run to an eductor/ejector/venturi to increase the total mass flow of air that is accelerated and utilised as thrust. At the same time, a vacuum effect created by the eductor/ejector/venturi in one or more pipes 275 helps create a larger pressure differential through the turbines 240, therefore increasing efficiency and decreasing the amount of air required from initial compressor 215 to power turbines 240. The end result being that a larger component of air mass from initial compressor 215 can be used directly for thrust. Alternatively, if a lesser mass/weight of air is acceptable but a large volume of higher pressure air is the desired result, the small portion of low pressure air from one or more pipes 275 can be exhausted to atmosphere as waste and the remaining bulk of the airflow maintains a higher pressure and average velocity.

One or more pipes 280 provide one or more engine exhaust pipes. The exhaust pipe(s) 280 can transport engine exhaust gases and perform any of the following tasks depending on system requirements:

(1) exhaust air can be expelled from the propulsion system 200 to atmosphere (standard exhaust pipe).

(2) exhaust air can be directed to optional ejector 290 and added to the total air mass providing the thrust of the propulsion system (the embodiment as illustrated).

(3) exhaust air can be utilised to power an optional “hot turbocharger”, as found in normal application of turbochargers. The hot turbocharger includes an exhaust flow turbine 282 and an exhaust flow compressor 283. Turbine 282 is positioned in-line in one or more pipes 280 to be driven by hot exhaust gases from engine 205. Exhaust flow turbine 282 in turn drives exhaust flow compressor 283 which can be used to force compressed air along one or more pipes 284 so that this additional air mass (i.e. exhaust flow compressor output flow) is added to the high pressure air mass in one or more pipes 260. This can achieve increased power and/or total thrust.

Turbocharger compressors 245 can be the same as turbocharger compressor 145 as previously described. In another embodiment, axial flow turbines, blow down turbines, etc., can be added after the turbines 240 to extract further energy from the airflow, noting that the vacuum or partial vacuum applied to the lower pressure side of the turbine increases the available energy for a given input on the higher pressure side of the turbine.

In a further embodiment, in relation to compressors 245, pressure is of importance as a De Laval nozzle is most responsive to additional pressure as opposed to volume. The increased efficiency of the turbine sections allows for the introduction of axial flow compressors to increase pressure, volume or both. A combination of axial flow and centrifugal flow compressors could be used to achieve maximum increases in pressure and volume whilst maintaining high velocity values in one or more pipes 265.

It should also be noted that depending on the degree to which the pressures and velocities are matched between adjoining one or more pipe sections (e.g. manifolds) or components, non return valves (i.e. check valves, clack valves, or one-way valves) may be used, or required, at various locations to avoid reverse airflow within the propulsion system. Non return valves also may be used to reduce losses in the event of component failure. For example, non return valves 295 can be used in one or more pipes 235 and positioned on the high pressure side of turbines 240.

### Further Example of a Thrust Propulsion System

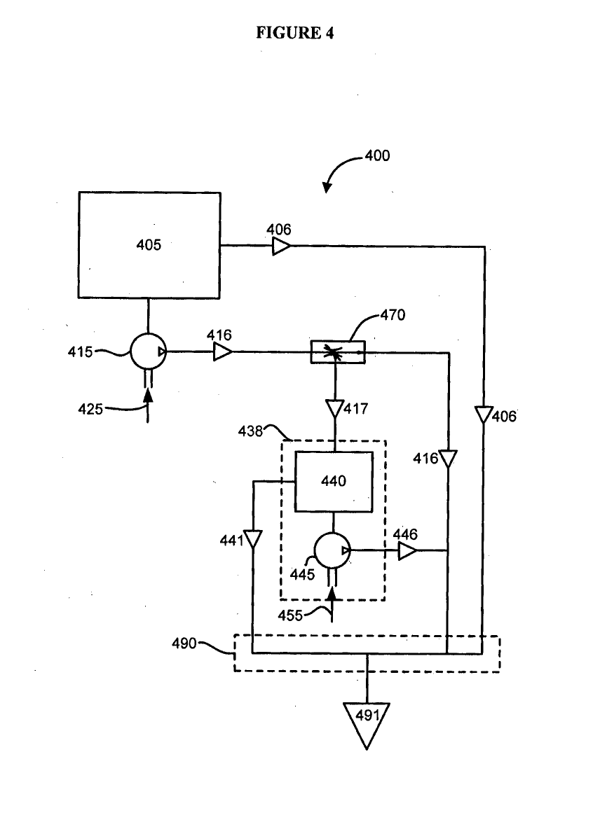

Referring to FIG. 4 there is illustrated a thrust propulsion system 400 that shows example air mass flows in the system.

Engine 405 can be any form of engine and need not necessarily produce exhaust gases. In one form engine 405 is an internal combustion engine and produces exhaust flow 406 (references to flow refer to air and/or other gas flow, for example those produced by operation of the engine) that is directed to exit device 490, which may be, or include, an ejector, eductor, nozzle, pipe, individually or in combination; or any other device as previously discussed. Engine 405 drives first compressor 415 that intakes ambient flow 425 (e.g. ambient air) and produces first compressor output flow 416 (e.g. compressed or pressurised air). Nozzle 470, being any suitable nozzle, directs or controls first compressor output flow 416 and can produce, direct or manage turbine input flow 417. Nozzle 470, or a plurality of nozzles, can be located in a variety of different locations to produce the desired outcome, for example at the flow junction as illustrated, on a turbine input pipe(s) or after a turbine input pipe(s) junction and downstream towards exit device 490.

Turbocharger 438 includes turbine 440 and second compressor 445 (i.e. the turbocharger's compressor). Turbine 440 is driven by turbine input flow 417 (i.e. at least part of the first compressor output flow, preferably a relatively small part) and in turn drives second compressor 445 that intakes ambient flow 455 (e.g. ambient air). Turbine output flow 441 (i.e. lower pressure air/gas) is directed to exit device (e.g. ejector) 490, or in another version can be directly fed to the atmosphere. Second compressor 445 produces second compressor output flow 446 (e.g. compressed air).

Preferably, all or substantially all of second compressor output flow 446, or otherwise at least part of second compressor output flow 446, is combined with first compressor output, flow 416, or at least part of the first compressor output flow that is remaining after splitting off the turbine input flow 417, and the combined output flows 416, 446 are directed to exit device (e.g. ejector) 490.

As previously discussed ejector 490, which is optional, can be a variety of devices, nozzles, pipes, etc. For example, exit device/ejector 490 could be a device or a system of components including an eductor or a venturi type tube or arrangement in combination with a nozzle. That is, ejector 490 could operate to provide a Bernoulli effect or a Venturi effect at the air/gas exit region. Ejector 490 can include or be used in conjunction with one or more high velocity air/gas exit nozzles. Ejector 490 can be used, optionally, to create a vacuum, partial vacuum or reduced pressure in turbine output flow 441 which has the effect of increasing the pressure drop across turbine 440 and improving operation. Exit device/ejector 490 can be used to combine or manipulate one or more of flows 406, 416 and/or 441 in any achievable and desirable manner, or may not receive one of the indicated flows at all for example flow 441 or flow 406. Ejector 490 could be or include one or more nozzles to assist in providing exit thrust. Ejector output flow 491 is a relatively high velocity flow that provides thrust to or acting on propulsion system 400.

In alternate embodiments, system 400 can be used to provide a high volume or velocity air mass as opposed to a propulsion system.

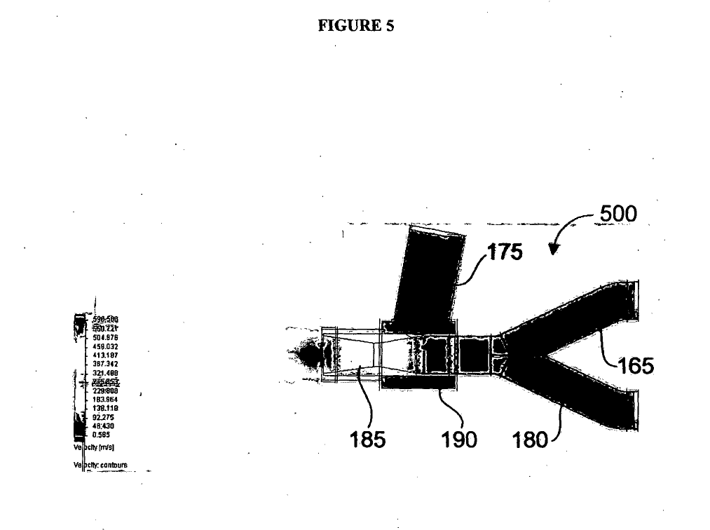

Referring to FIG. 5 there is illustrated a partial cross-section of an example manifold 500 near the thrust nozzle region for a thrust propulsion system, for example system 100. Pipe 165 and pipe 180 join so that a compressed air flow is combined with an engine exhaust gas flow, with the combined air/gas mass directed to high velocity nozzle 185. Pipe 175 directs low pressure air to the exit device 190 (being a combined ejector and nozzle 185 unit as illustrated) that acts to further reduce the air pressure in pipe 175, thereby creating an increased pressure differential across turbine 140. Air velocities indicated in the shaded scale bar in m/s are by way of example only and are not limiting to the present invention.

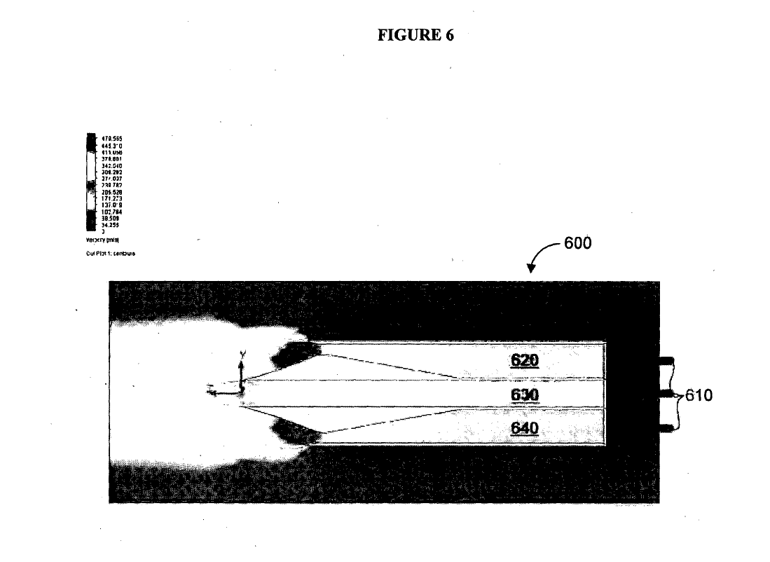

Referring to FIG. 6 there is illustrated a partial cross-section of an example nozzle 600 near the thrust producing exit region for a thrust propulsion system, for example system 100. Nozzle 600 is based on a variation of a linear aerospike engine, and is significantly varied for use with the present thrust propulsion systems. A conventional linear aerospike is a type of rocket engine that uses an axisymmetric plug nozzle, in combination with a torus-shaped combustion chamber and a turbine exhaust system that injects the turbine drive gases into the nozzle base, to achieve a shorter length geometry compared to a conventional rocket engine. It is a member of the class of altitude compensating nozzle engines. One or, more manifolds direct manifold air 610 to linear aerospike nozzle 600, being a variation of a conventional nozzle used in a linear aerospike engine. In region 620 is highly compressed air, for example exiting from a combination of one or more pipes 165 and/or one or more pipes 180. In region 630 is expelled low pressure air, for example exiting from a combination of one or more pipes 175 and/or an exit device 190. In region 640 is highly compressed air, for example exiting from a combination of one or more pipes 165 and/or one or more pipes 180. Air velocities indicated in the shaded scale bar in m/s are by way of example only and are not limiting to the present invention.

It should be appreciated that a variety of other or different nozzle designs, exit region manifolds and/or exit devices are possible to produce thrust for use with the thrust propulsion system.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A propulsion system comprising:
an engine;
a first compressor able to be driven by the engine, the first compressor for producing a first compressor output flow;
a turbine able to be driven by at least part of the first compressor output flow; and
a second compressor able to be driven by the turbine, the second compressor for producing a second compressor output flow;
wherein in operation at least part of the second compressor output flow and at least part of the first compressor output flow are combined to produce thrust.

2. The propulsion system of claim 1, wherein a flow controller controls an amount of the first compressor output flow directed to the turbine.

3. The propulsion system of claim 2, wherein the flow controller is positioned between the first compressor and the turbine.

4. The propulsion system of claim 2, wherein the flow controller is positioned between the first compressor and an exit device.

5. The propulsion system of claim 1, wherein the turbine and the second compressor are part of a turbocharger.

6. The propulsion system of claim 1, wherein in operation a turbine output flow exits the turbine.

7. The propulsion system of claim 6, wherein the turbine output flow is directed to an exit device.

8. The propulsion system of claim 7, wherein the exit device includes an ejector, eductor, nozzle and/or pipe.

9. The propulsion system of claim 7, wherein in operation the exit device causes a decrease in pressure of the turbine output flow.

10. The propulsion system of claim 1, wherein in operation the engine produces an exhaust flow, and the exhaust flow contributes to produce the thrust.

11. The propulsion system of claim 10, wherein the exhaust flow is directed to an exit device and bypasses the turbine.

12. The propulsion system of claim 1, wherein the engine is an internal combustion engine.

13. The propulsion system of claim 1, wherein the engine is a jet aircraft engine.

14. The propulsion system of claim 1, wherein the thrust acts on the propulsion system.

15. The propulsion system of claim 1, wherein the first compressor output flow and the second compressor output flow are comprised of air and/or other gases.

16. The propulsion system of claim 1, wherein the first compressor output flow and the second compressor output flow are directed within pipes.

17. A propulsion system comprising:
at least one engine;
at least one first compressor able to be driven by the at least one engine, the at least one first compressor for producing at least one first compressor output flow;
a plurality of turbines able to be driven by at least part of the at least one first compressor output flow; and,
a plurality of second compressors able to be driven by one or more of the plurality of turbines, the plurality of second compressors for producing a plurality of second compressor output flows;
wherein in operation at least part of the plurality of second compressor output flows and at least part of the at least one first compressor output flow are combined to produce thrust.

18. The propulsion system of claim 17, wherein one or more flow controllers control an amount of the at least one first compressor output flow directed to each of the plurality of turbines.

19. The propulsion system of claim 17 or 18, wherein in operation the at least one engine produces at least one exhaust flow, and the at least one exhaust flow is directed to an exit device and bypasses the plurality of turbines.

20. The propulsion system of claim 19, wherein in operation the at least one exhaust flow is directed to at least one separate exhaust flow turbine before the exit device.

21. The propulsion system of claim 20, wherein in operation the at least one exhaust flow turbine drives at least one exhaust flow compressor that produces at least one exhaust flow compressor output flow which is combined with the plurality of second compressor output flows and/or at least part of the at least one first compressor output flow.

22. The propulsion system of claim 7, wherein the exit device includes a De Laval nozzle and an ejector.
